(19) United States
(12) Patent Application Publication
(10) Pub. No.: US 2002/0101538 A1
(43) Pub. Date: Aug. 1, 2002

(54) Method of storing or transferring additional information, and receiver therefor

(76) Inventors: Tsuyoshi Kano, Tokyo (JP); Shigeru Kaneko, Kanagawa (JP)

Correspondence Address: COOPER & DUNHAM LLP, 1185 Avenue of the Americas, New York, NY, 10036, US

(21) Appl. No.: 10/021,875

(22) Filed: Dec. 17, 2001

(30) Foreign Application Priority Data
Dec. 22, 2000 (JP) P2000-389872
Dec. 22, 2000 (JP) P2000-389873

(51) Int. Cl. H04N 11/00

(52) U.S. Cl. 348/465; 348/553

(57) ABSTRACT

A user presets in a PC information, such as the user's favorite program categories, artist names, as key information. A receiver receives a digital radio broadcast in which additional information is multiplexed with audio information. The received additional information is transferred to the PC via communications means. The PC determines whether the preset key information is included in the additional information. If the key information is included, the additional information is stored in a storage device as an additional information file. Alternatively, the additional information is transmitted on a communications network with an ID of an information processing terminal at a user-specified destination attached thereto. The arrangement may be such that when a connection is established between the receiver and the PC via the communications means, the key information is transmitted from the PC to the receiver so that additional information can be selected on the receiver.

### BACKGROUND OF THE INVENTION

1. Field of the Invention

The present invention relates to receivers. More specifically, the present invention relates to a receiver capable of receiving a broadcast in which additional information is multiplexed with main information including audio information (acoustic signal) or video information, such as a digital radio broadcast. The present invention also relates to a method of storing the additional information obtained by receiving the broadcast and a method of transferring the additional information to a location remote from the receiver.

2. Description of the Related Art

Digital radio broadcasting service has already begun in Europe as DAB (Digital Audio Broadcasting) based on Eureka 147, and has been proposed in Japan and the United States.

In digital radio broadcasting, high-quality transmission of audio information such as music can be achieved, and furthermore, additional information associated with a program, such as text data and image files, can be multiplexed and broadcast with the main audio information.

The list of proposed types of additional information includes: (1) ID of broadcasting service, and information such as title and category; (2) information regarding program content, e.g., information such as artist name and song title in the case of a music program; (3) timestamp (time-of-day information); and (4) other accompanying information).

In the case of a music program, the accompanying information is, for example, text data showing words of a song broadcast in the program, concert information of an artist on the program, etc. It is also possible, for example, to compress the jacket of a CD including a song broadcast in the program based on JPEG (Joint Photographic Experts Group) format, broadcasting the payload (the substantial data) of the JPEG file and header information indicating a JPEG file as the accompanying information which constitutes part of the additional information.

In a receiver capable of receiving a digital radio broadcast of the type described above, additional information received together with audio information is stored on a memory and displayed on a display such as an LCD (liquid crystal display).

However, because the memory of the receiver is of relatively small capacity, the memory is not capable of storing a large amount of data. Furthermore, data processing capability of a receiver is relatively low. Therefore, secondary use of the additional information is not allowed, in particular, use of the additional information at a location remote from the receiver. Furthermore, the screen of the display is relatively small, resulting in an unsatisfactory display quality.

As a measure against the problems described above, the additional information received by the receiver may be transferred to an information processing terminal such as a PC (personal computer), so that the additional information is displayed on a display having a larger screen and store an a storage device having a larger capacity. This allows storage of a large amount of additional information and therefore secondary use of the additional information, and also allows simultaneous display of a large amount of additional information, achieving variety in display. Furthermore, the additional information may be transferred from the information processing terminal onto a communications network and thereby transferred to other information processing terminals connected to the communications network. This allows secondary use of the additional information, in particular, use of the additional information at a location remote from the receiver.

The method of storing or transferring the additional information on the information processing terminal will, for example, (1) directly store or transfer all the information transferred from the receiver; (2) store or transfer additional information currently displayed based on user's selection; or (3) store or transfer additional information of programs which have been reserved using a timer.

However, according to the method (1), information unnecessary for the user, as well as desired information, will be stored or transferred, causing inefficiency with regard to the storage capacity of the information processing terminal and information traffic through the communications path. Furthermore, it will be laborious for the user to search for and browse desired information later.

According to the method (2), the additional information cannot be stored or transferred if the user is not present at the location of the receiver during reception. According to the method (3), the additional information cannot be stored or transferred if the user is not aware of the existence or the content of a program in advance.

Furthermore, with regard to the method (3), in digital radio broadcasting, EPG (electronic program guide) is not necessarily sent. Even if it is sent, if the user does not take a look at it, or if only the program title and program category are shown, it is unknown which song of which artist will be broadcast.

### SUMMARY OF THE INVENTION

Accordingly, it is an object of the present invention to provide a method of storing additional information, a method of transferring additional information, and a receiver, so that of additional information received by a receiver, information desired by the user is stored on an information processing terminal efficiently using the storage capacity of the information processing terminal, even if the user is absent at the location of the receiver during reception or if the user is not aware of the existence or the content of a program in advance. It is another object of the present invention to allow transferring to and receiving the additional information at a location remote from the receiver.

To these ends, the present invention, in one aspect thereof, provides a method of storing additional information, including the steps of receiving additional information obtained and transferred by a receiver capable of receiving a broadcast in which the additional information is multiplexed with main information including an audio signal or a video signal; determining whether preset key information is included in the transferred additional information; and storing the additional information in a storage medium if the key information is included.

The present invention, in another aspect thereof, provides a method of transferring additional information, including the steps of receiving a broadcast in which additional information is multiplexed with main information including an audio signal or a video signal, thereby obtaining the additional information; determining whether preset key information is included in the additional information obtained; and transferring the additional information to an external device if the key information is included.

The present invention, in another aspect thereof, provides a method of storing additional information, including the steps of receiving a broadcast in which additional information is multiplexed with main information including an audio signal or a video signal, thereby obtaining the additional information; determining whether preset key information is included in the additional information obtained; transferring the additional information to an information processing terminal if the key information is included; and storing the additional information transferred to the information processing terminal in a storage medium of the information processing terminal.

The present invention, in another aspect thereof, provides a receiver including a receiving unit capable of receiving a broadcast in which additional information is multiplexed with main information including an audio signal or a video signal; a control unit which determines whether key information preset in the receiver is included in the additional information received by the receiving unit; and a communications unit which transfers the additional information received by the receiving unit to an external device if the control unit determines that the key information is included in the additional information.

The present invention, in another aspect thereof, provides an information processing terminal including a data communications unit for receiving additional information obtained and transferred by a receiver capable of receiving a broadcast in which the additional information is multiplexed with main information including an audio signal or a video signal; a control unit which determines whether preset key information is included in the transferred additional information; and a storage device for storing the additional information if the control unit determines that the key information is included in the additional information.

The present invention, in another aspect thereof, provides a method of transferring additional information, including the steps of transmitting to a first information processing terminal additional information obtained by a receiver capable of receiving a broadcast in which the additional information is multiplexed with main information including an audio signal or a video signal; determining on the first information processing terminal whether key information preset in the first information processing terminal is included in the transmitted additional information; and transferring the additional information from the first information processing terminal to a second information processing terminal at a destination if the key information is included.

The present invention, in another aspect thereof, provides a method of transferring additional information, including the steps of receiving additional information by a receiver capable of receiving a broadcast in which the additional information is multiplexed with main information including an audio signal or a video signal; determining on the receiver whether key information preset in the receiver is included in the received additional information; transmitting the additional information to a first information processing apparatus at a source if the key information is included; and transferring the additional information from the first information processing terminal to a second information processing terminal at a destination via a communications network.

The present invention, in another aspect thereof, provides an information processing terminal including a data communications unit for receiving additional information obtained and transferred by a receiver capable of receiving a broadcast in which the additional information is multiplexed with main information including an audio signal or a video signal; a control unit which determines whether preset key information is included in the transferred additional information; and a network communications unit for transmitting the additional information onto a communications network if the control unit determines that the key information is included in the additional information.

Accordingly, of the information received by the receiver, only additional information including the key information preset by the user in the information processing terminal or the receiver, such as the user's favorite program categories and artist names, is stored on the information processing terminal. Accordingly, information desired by the user is stored on the information processing terminal efficiently using the storage capacity of the information processing terminal.

Furthermore, by entering key information in the information processing terminal or the receiver in advance, the user is allowed to correctly store desired additional information on the information processing terminal even if the user is absent during reception or the user is not aware of a program in advance.

Furthermore, of the additional information received by the receiver, only additional information including the key information preset by the user in the information processing terminal at the source or the receiver, such as the user's favorite program categories and artist names, is transferred from the information processing terminal at the source to the information processing terminal at the destination via the communications network. Accordingly, the user is allowed to correctly transfer only desired additional information to a location remote from the receiver and receive the additional information at the remote location, even if the user is absent at the location of the receiver during reception or if the user in not aware of a program in advance.

### BRIEF DESCRIPTION OF THE DRAWINGS

FIG. 1 is an illustration of a system for implementing a method of storing additional information or a method of transferring additional information according to an embodiment of the present invention;

FIG. 2 is a block diagram of a receiver according to the embodiment of the present invention;

FIG. 3 is a block diagram of an example of an information processing apparatus used for implementing a method of storing additional information according to the embodiment of the present invention;

FIG. 4 is a flowchart showing a transfer routine to be executed by a CPU of a receiver in a first embodiment of additional information storing method and a first embodiment of additional information transfer method according to the present invention;

FIG. 5 is a flowchart showing a storing routine to be executed by a CPU of an information processing terminal in the first embodiment of additional information storing method according to the present invention;

FIG. 6 is a flowchart showing a transfer routine to be executed by a CPU of a receiver in a second embodiment of additional information storing method and a second embodiment of additional information transfer method according to the present invention;

FIG. 7 is a flowchart showing a storing routine to be executed by a CPU of an information processing terminal in the second embodiment of additional information storing method;

FIG. 8 is a flowchart showing a transfer routine to be executed by a CPU of an information processing terminal when additional information stored on the information processing terminal is transferred to and displayed on a receiver;

FIG. 9 is a flowchart showing a display routine to be executed by a CPU of a receiver when additional information stored on an information processing terminal is transferred to and displayed on the receiver;

FIG. 10 is a diagram showing a system for implementing a method of transferring additional information according to an embodiment of the present invention;

FIG. 11 is a flowchart showing a transmission routine to be executed by a CPU of an information processing terminal at a source in the first embodiment of additional information transfer method according to the present invention; and

FIG. 12 is a flowchart showing a transmission routine to be executed by a CPU of an information processing terminal at a source in the second embodiment of additional information transfer method according to the present invention.

### DESCRIPTION OF THE PREFERRED EMBODIMENTS

Receiver and Storage System

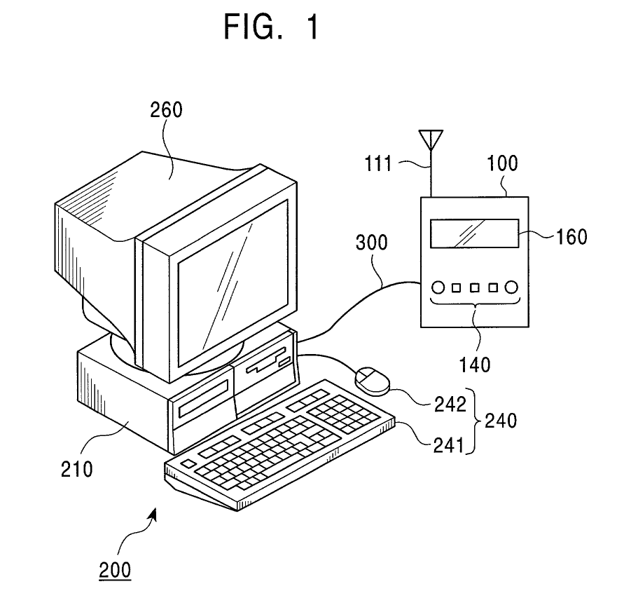

FIG. 1 shows a system for implementing a method of storing additional information according to an embodiment of the present invention. In the system, a receiver 100 and an information processing apparatus, a PC 200 herein, are connected via communication means 300.

The receiver 100 is capable of receiving a digital radio broadcast in which additional information is multiplexed with audio information. The receiver 100 includes an operation unit 140 having various buttons, keys, etc., a display unit implemented herein by a liquid crystal display (LCD) 160, and a data communications unit to be described later, and is connected to an antenna 111.

The PC 200 includes a main unit 210 including a CPU and a storage device, an operation unit 240 including a keyboard 241, a mouse 242, etc., a display unit 260 such as a CRT display or an LCD, a data communications unit to be described later, and a network communications unit to be described later.

The communications means 300 allows communications between the receiver 100 and the PC 200 by wire or wireless based on, for example, USB (Universal Serial Bus) or Bluetooth (a standard for short-distance wireless communications), and has a transmission rate sufficient for transfer of additional information.

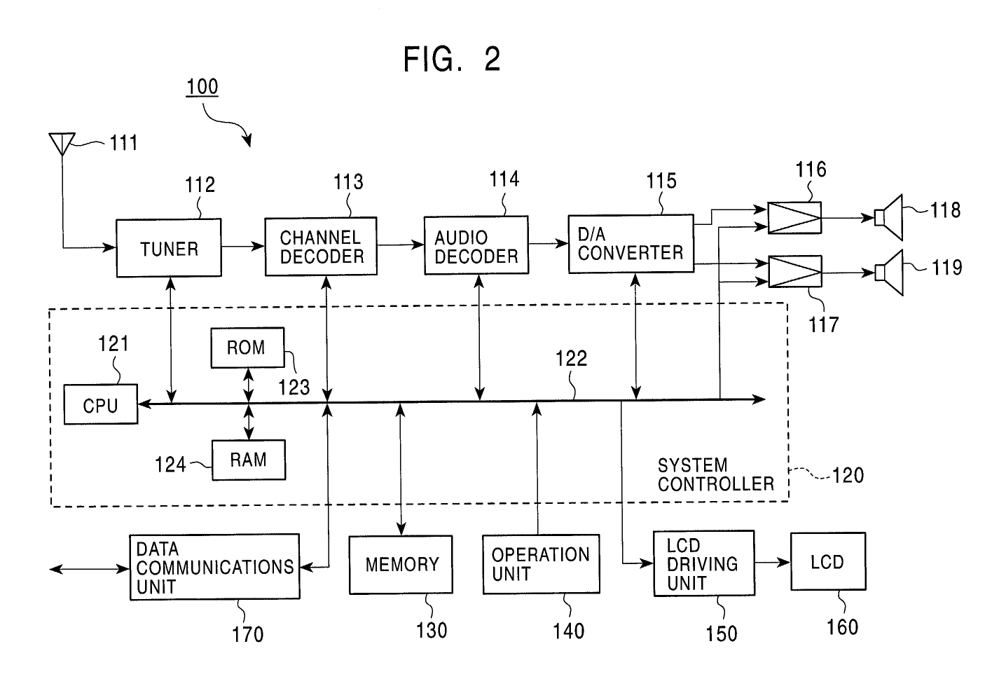

FIG. 2 shows the receiver 100 in the embodiment. In digital radio broadcasting, audio information is digitized by PCM (pulse code modulation), compressed, for example, based on MPEG (Moving Picture Experts Group)-1 Audio Layer-II, and channel-coded (with error correction function). Furthermore, additional information is also channel-coded. The audio information and the additional information are then multiplexed and modulated, for example, by OFDM (orthogonal frequency division multiplexing), and transmitted in the form of an RF signal.

In the receiver 100, a tuner 112 selects a broadcast signal received by an antenna 111. The signal is frequency-converted for demodulation, and then channel-decoded in a channel decoder 113. Furthermore, audio information included in the broadcast signal is expanded in an audio decoder 114 and converted into an analog signal in a D/A converter 115. The analog audio signal is amplified in audio amps 116 and 117, and then supplied to speakers 118 and 119.

The receiver 100 may be implemented, for example, as an on-vehicle device or as a portable device. In the former case, the speakers 118 and 119 will be provided on vehicles, and in the latter case, for example, headphones or earphones will be connected instead of the speakers 118 and 119.

The additional information which has been channel-decoded in the channel decoder 113 is fed to a system controller 120 of the receiver 100.

The system controller 120 includes a CPU 121, a ROM 123, and a RAM 124 connected to each other via a bus 122. The ROM 123 stores programs of a routine for storing additional information, a sorting routine, a routine for searching within current broadcast, a routine for wait reception, etc. to be described later, and static data such as text fonts for displaying the additional information. The RAM 124 functions as a work area for the CPU 121.

Furthermore, a memory 130 for storing the additional information is connected to the bus 122. Alternatively, however, a portion of the RAM 124 may be used in place of the memory 130. The memory 130 is implemented with a relatively small storage capacity, and therefore, when the memory 130 becomes full, older additional information is deleted in order to accommodate new additional information.

Furthermore, an operation unit 140, an LCD driving unit 150, and a data communications unit 170 are connected to the bus 122, and the LCD 160 is connected to the LCD driving unit 150. The data communications unit 170 constitutes part of the communications means 300 described earlier.

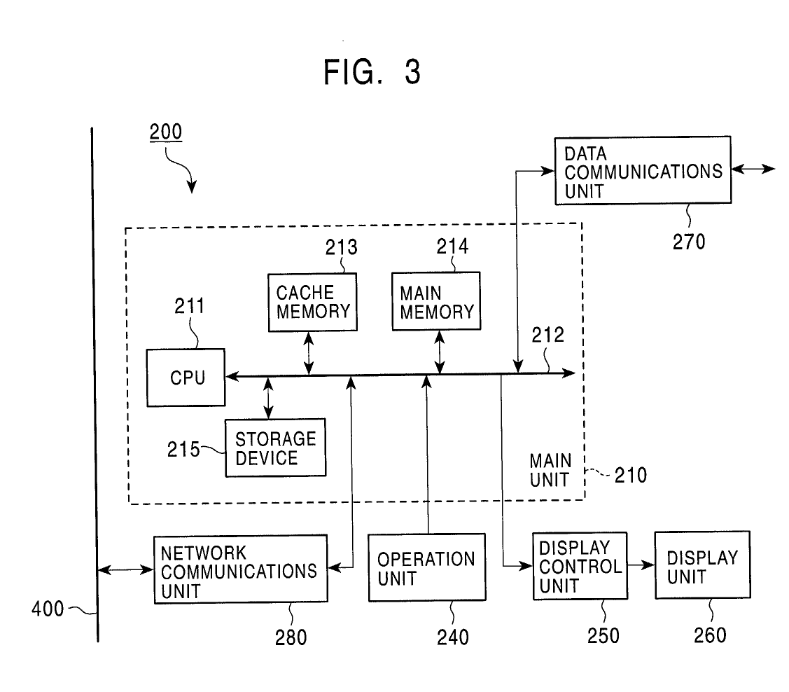

FIG. 3 shows the PC 200 in the embodiment. The PC 200 includes a CPU 211, a cache memory 213, a main memory 214, and a storage device 215 connected to each other via a bus 212. The storage device 215 is, for example, a hard disk device. The storage device 215 stores an OS (operating system) and application programs including a storing routine to be described later and also stores additional information transferred from the receiver 100 as will be described later.

Furthermore, an operation unit 240, a display control unit 250, and a data communications unit 270 are connected to the bus 212, and a display unit 260 is connected to the display control unit 250. The data communications unit 270 constitutes part of the communications unit 300 described earlier.

Method of Storing Additional Information

First Embodiment

According to a first embodiment of additional information storing method, in the system described above, the additional information received and obtained by the receiver 100 is transferred to the PC 200 via the communications means 300. It is determined on the PC 200 whether key information preset in the PC 200 is included in the additional information transferred from the receiver 100. If the key information is included, the additional information is stored in the storage device 215.

The key information is preset in the PC 200 by the user using the operation unit 240. The key information corresponds to information which may be included in the additional information, for example, the user's favorite program categories and artists. For example, if the additional information is in the form of text data, the key information corresponds to a character string which may be included in the payload of the additional information.

The key information is not limited to a single keyword, and may be set using a plurality of keywords with logic OR and logic AND.

Regarding the key information, for example, the name of an artist “Taro Yamada” will not always be described as “Taro Yamada” in the additional information multiplexed with audio information, and may be described instead as “Yamada Taro”, “TARO Yamada”, “T. Yamada”, “TARO YAMADA”, etc. Similarly, as for the name of an American artist, several descriptions are possible, for example, the middle name being included or omitted. Furthermore, the description may differ depending on the country in which the program is broadcast and the character system used in the region. For example, the description may be in Chinese characters.

It is laborious for the user to enter several different keywords as key information with all the above in mind. Furthermore, it is possible that the user himself enters, for example, “Yamada Taro” or “TARO YAMADA” instead of “Taro Yamada”.

Thus, software for the storing routine to be executed by the CPU 211 of the PC 200 is implemented so that when the CPU 211 determines whether the key information is included in the additional information, it is determined that the key information is included in the additional information if the additional information differs from the key information only within several variations of description as described above.

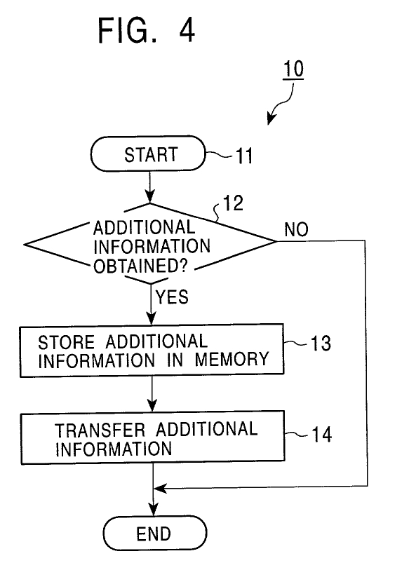

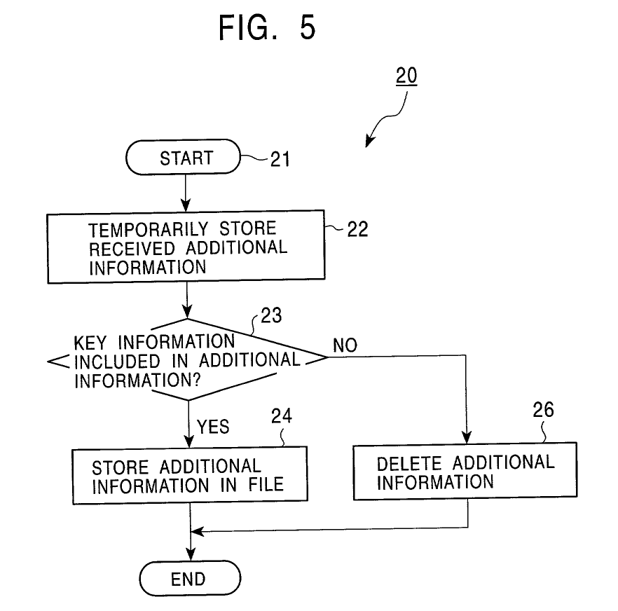

FIGS. 4 and 5 respectively show a transfer routine to be executed by the CPU 121 of the receiver 100 and a storing routine to be executed by the CPU 211 of the PC 200 when additional information is selected on the PC 200.

Referring to FIG. 4, the CPU 121 of the receiver 100 starts the transfer routine 10 upon reception of a broadcast in step 11. First, it is determined in step 12 whether the additional information of the received program has been obtained. If the additional information has been obtained, the routine proceeds to step 13, in which the additional information is stored in the memory 130. The routine then proceeds to step 14, in which the data communications unit 170 transfers the additional information to the PC 200. If it is determined in step 12 that the additional information has not been obtained, the routine is exited.

Referring next to FIG. 5, the CPU 211 of the PC 200 starts the storing routine 20 when the data communications unit 270 receives the additional information from the receiver 100 in step 21. First, in step 22, the received additional information is temporarily stored in the main memory 214. The routine then proceeds to step 23, in which it is determined whether the key information which has been set in the PC 200 as described earlier is included in the additional information. If the additional information is included, the routine proceeds from step 23 to step 24, in which the additional information is stored in the storage device 215 as an additional information file.

If the key information is not included in the additional information temporarily stored in the main memory 214, the routine proceeds from step 23 to step 26, in which the additional information is deleted from the main memory 214, and the storing routine is exited.

According to the embodiment described above, of the additional information received by the receiver 100, information desired by the user is stored on the PC 200 efficiently using the storage capacity of the storage device 215 of the PC 200. In addition, the information can be stored correctly on the PC 200 even if the user is absent during reception or the user is not aware of the existence or the content of a program in advance.

The additional information is, for example, of the type that includes a header portion and a data portion. The header portion includes information indicating the format, data length, etc. of the payload in the data portion. For example, if the payload in the data portion is a JPEG file, the header portion includes information indicating a JPEG file, the data length or the image size.

In this case, by implementing so that the receiver 100 transfers to the PC 200 the header portion as well as the data portion of the additional information, the user is allowed to set information which may be included in the header portion of the additional information, for example, information indicating the format of the payload in the data portion, as key information, so that only the payload in the data portion is stored on the PC 200.

Although the embodiment has been described in the context of storing only additional information including key information on the PC 200, the method may be such that in addition to the additional information, audio information of the associated program is also transferred from the receiver 100 to the PC 200, so that additional information including the key information and the audio information of the associated program are stored on the PC 200. Accordingly, the user is allowed to display the additional information and to listen to the audio information (audio signal) on the PC 200.

Furthermore, information obtained by the PC 200, for example, a timestamp, user information such as tags and headings input by the user, may be additionally stored in the additional information file as accompanying information, so that the file can be readily searched and browsed later by the user.

Furthermore, depending on the type of digital radio broadcast, additional information of all the programs in broadcast including the additional information of the program being received can be received. In that case, the receiver 100 receives the additional information of all the programs in broadcast and transfers the additional information to the PC 200, and the PC 200 stores additional information including key information. Accordingly, the user is allowed to obtain additional information of other programs as well as that of the program being received.

Although the embodiment has been described in the context of transferring additional information to the PC 200 upon reception thereof, alternatively, the method may be such that plural sets of additional information are stored in the memory 130 and the additional information is transferred to the PC 200 at a predetermined timing, for example, when the remaining capacity of the memory 130 falls under a predetermined value, or at a predetermined interval (e.g., 30 minutes, one hour, etc.). Furthermore, additional information may be transferred from the receiver 100 to the PC 200 in response to a request for transfer of additional information issued from the PC 200 to the receiver 100.

Furthermore, the additional information which has been transferred from the PC 200 is deleted from the memory 130 of the receiver 100, preferably after the receiver 100 has received an acknowledgement from the PC 200.

Second Embodiment

According to a second embodiment of additional information storing method, in the system described already, the receiver 100 determines whether the key information is included in the received additional information, and the additional information is transferred to the PC 200 if the key information is included.

The key information is set in the PC 200, for example, by the user using the operation unit 240 in advance, and transmitted from the PC 200 to the receiver 100 when a connection is established between the receiver 100 and the PC 200 via the communications means 300. Alternatively, the key information may be set in advance by the user in the receiver 100 using the operation unit 140 thereof.

Also in the second embodiment, software for the transfer routine to be executed by the CPU 121 of the receiver 100 is implemented so that when the CPU 121 determines whether the key information is included in the additional information, it is determined that the key information is included in the additional information if the additional information only differs from the key information within several variations of description as described earlier.

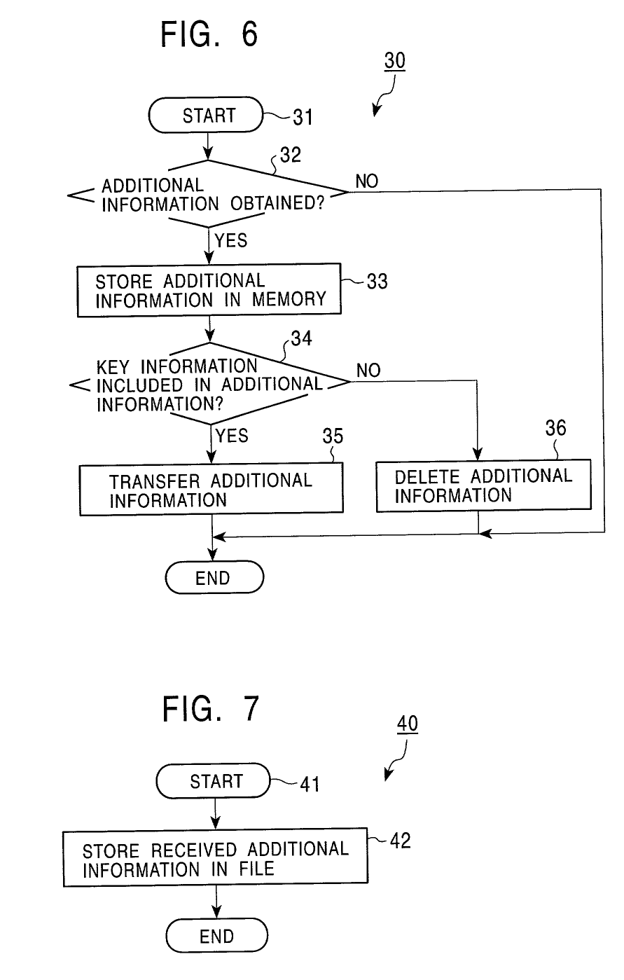

FIGS. 6 and 7 respectively show a transfer routine to be executed by the CPU 121 of the receiver 100 and a storing routine to be executed by the CPU 211 of the PC 200 when additional information is selected on the receiver 100.

Referring to FIG. 6, the CPU 121 of the receiver 100 starts the transfer routine 30 upon reception of a broadcast in step 31. First, in step 32, it is determined whether the additional information of the received program has been obtained. If the additional information has been obtained, the routine proceeds to step 33, in which the additional information is stored in the memory 130. The routine then proceeds to step 34, in which it is determined whether the key information which has been transferred from the PC 200 to the receiver 100 or which has been set in the receiver 100 is included in the additional information. If the key information is included, the routine proceeds from step 34 to step 35, in which the data communications unit 170 transfers the additional information to the PC 200. If it is determined in step 34 that the key information is not included in the additional information, or if it is determined in step 32 that the additional information of the program has not been obtained, the routine is exited immediately.

If the key information is not included in the additional information stored in the memory 130, the transfer routine is exited without transferring the additional information to the PC 200. In this case, the additional information temporarily stored in the memory 130 and not including the key information is deleted in step 36.

Referring next to FIG. 7, the CPU 211 of the PC 200 starts the storing routine 40 when the data communications unit 270 receives the additional information from the receiver 100 in step 41. In step 42, the received additional information is directly stored in the storage device 215 as an additional information file.

According to the second embodiment described above, similarly to the first embodiment, of the additional information received by the receiver 100, information desired by the user can be stored on the PC 200 efficiently using the storage capacity of the storage device 215 of the PC 200. In addition, the additional information can be stored correctly on the PC 200 even if the user is absent during reception or the user is not aware of the existence or the content of a program in advance.

Also in the second embodiment, if the additional information includes a header portion and a data portion, the user is allowed to set information which may be included in the header portion of the additional information as key information. Furthermore, in addition to the additional information including the key information, audio information of the associated program may be transferred from the receiver 100 and stored on the PC 200. Furthermore, information obtained by the PC 200 may be stored on the PC 200 as accompanying information in association with the additional information file.

Furthermore, the method may be such that the receiver 100 receives the additional information of all the programs in broadcast and transfers to and stores on the PC 200 additional information including specified key information.

Transfer of Stored Additional Information to Receiver and Display Thereof on Receiver

The additional information stored on the PC 200 in the manner described above can be transferred from the PC 200 to the receiver 100 via the communications means 300 and stored on the memory 130 of the receiver 100, so that the additional information can be displayed on the LCD 160.

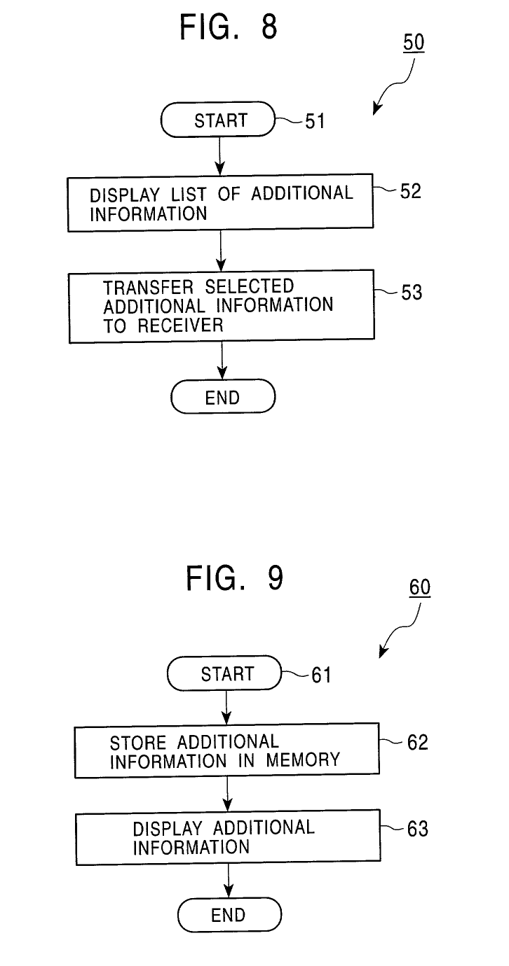

FIGS. 8 and 9 respectively show a transfer routine to be executed by the CPU 211 of the PC 200 and a display routine to be executed by the CPU 121 of the receiver 100.

Referring to FIG. 8, the CPU 211 of the PC 200 starts the transfer routine 50 when the user performs an operation to display the additional information stored in the storage device 215 on the display unit 260 in step 51. First, in step 52, a list of additional information stored in the storage device 215 is displayed on the display unit 260. In step 53, the user selects desired additional information from the list of additional information displayed on the display unit 260, so that the data communications unit 270 transfers the selected additional information to the receiver 100.

Referring next to FIG. 9, the CPU 121 of the receiver 100 starts the display routine 60 when the data communications unit 170 receives the additional information from the PC 200 in step 61. First, in step 62, the received additional information is stored in the memory 130. Then, in step 63, the user performs an operation to display the additional information stored in the memory 130 on the LCD 160.

Thus, the user is allowed to transfer to the memory 130 of the receiver 100 and display on the LCD 160 desired information in the additional information stored on the PC 200 as if taking a note on the receiver 100, which is useful, for example, in purchasing concert tickets, CDs, etc. Furthermore, the additional information transferred to the receiver 100 or part of the additional information may be selected and set as new key information.

Other Embodiments

Although the embodiments have been described in the context of receiving a digital radio broadcast in which additional information is multiplexed with audio information and storing the additional information on an information processing terminal, without limitation to digital radio broadcasting, the present invention may be generally applied to cases where a broadcast in which additional information multiplexed with audio or video information is received and the additional information is stored on an information processing terminal, for example, a digital television broadcast in which additional information is multiplexed with video (and audio) information.

Furthermore, the present invention may be applied to a case where a receiver is incorporated in an information processing terminal and integrated therewith.

As described above, according to the present invention, of the additional information received by a receiver, information desired by the user can be stored on an information processing terminal efficiently using the storage capacity of the information processing terminal. In addition, the additional information can be stored correctly on the information processing terminal even if the user is absent during reception or the user is not aware of the existence or the content of a program in advance.

Method of Transferring Additional Information

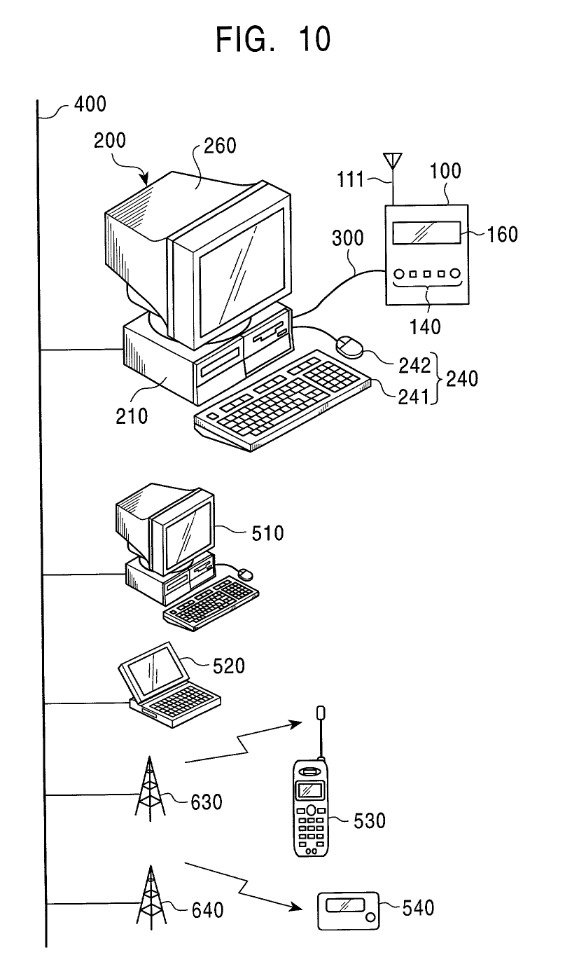

FIG. 10 shows a system for implementing a method of transferring additional information according to an embodiment of the present invention. Also in this system, a receiver 100 is connected to a PC 200 as an example of an information processing terminal at a source via communications means 300. Furthermore, the PC 200 is connected to a communications network 400. On the communications network 400, as examples of information processing terminals at destinations, PCs 510 and 520 are connected, and a cellular phone 530 and a pager 540 are linked via wireless communications means 630 and 640.

The receiver 100, the PC 200, and the communications means 300 are similar to those shown in FIGS. 1 to 3, and description of components already described will be omitted. A network communications unit 280 in the PC 200 transmits data onto and receives data from the communications network 400.

The communications network 400 is, for example, the Internet or a LAN (Local Area Network), and each of the information processing terminals connected or linked to the communications network 400, including the PC 200, the PCs 510 and 520, the cellular phone 530, and the pager 540, is assigned an ID which uniquely identifies the terminal, such as an IP (Internet Protocol) address.

First Embodiment

According to a first embodiment of additional information transfer method, in the system described above, the receiver 100 directly transmits the received additional information to the PC 200, the PC 200 determines whether the key information preset in the PC 200 is included in the additional information received from the receiver 100, and if the key information is included, the additional information is transmitted onto the communications network 400 and transferred to an information processing terminal at a destination specified in advance.

The key information set in the PC 200, and the method of selecting additional information based on the key information are the same as in the first embodiment of additional information storing method, and description thereof will be omitted. The information processing terminal at the destination is specified by the user in advance by entering an ID of the information processing terminal on the PC 200.

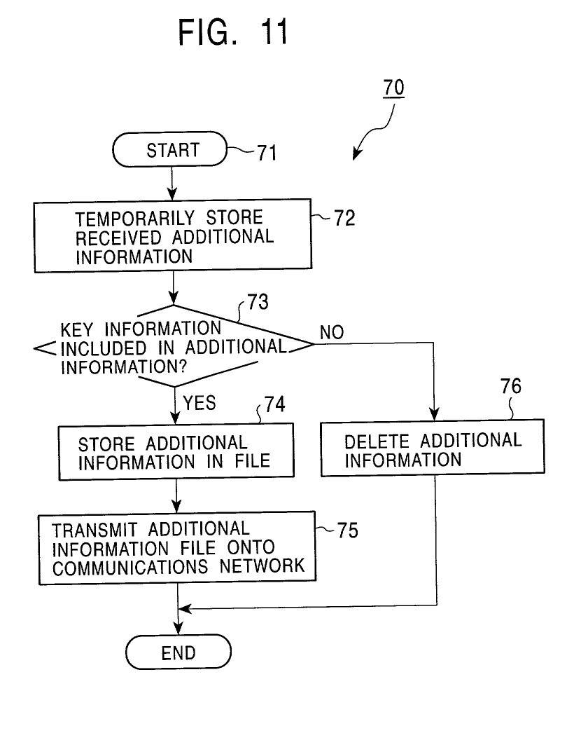

FIGS. 4 and 11 respectively show transmission routines to be executed by the CPU 121 of the receiver 100 and the CPU 211 of the PC 200. The transfer routine on the side of the receiver 100 is basically the same as in the embodiment described earlier.

Referring to FIG. 4, the CPU 121 of the receiver 100 starts the transmission routine 10 upon reception of a broadcast in step 11. First, in step 12, it is determine whether additional information of the received program has been obtained. The routine then proceeds to step 13, in which the additional information is stored in the memory 130. The routine then proceeds to step 14, in which the data communications unit 170 transfers the additional information to the PC 200.

Referring next to FIG. 11, the CPU 211 of the PC 200 starts the transmission routine 70 on the side of the PC 200 when the data communications unit 270 receives the additional information from the receiver 100 in step 71. First, in step 72, the received additional information is temporarily stored in the main memory 214. The routine then proceeds to step 73, in which it is determined whether the key information set in the PC 200 as described earlier is included in the additional information. If the key information is included, the routine proceeds from step 73 to step 74, in which the additional information is stored in the storage device 215 as an additional information file. The routine then proceeds to step 75, in which the network communications unit 280 transmits the additional information file onto the communications network 400.

The additional information file is converted based on a protocol for the communications network 400, such as the Internet Protocol, assigned an ID of the PC 200 at the source and an ID of an information processing terminal at a destination specified by the user before being transmitted onto the communications network 400. Accordingly, the information processing terminal at the specified destination is allowed to receive the additional information including the key information.

If the key information is not included in the additional information temporarily stored in the main memory 214, the routine proceeds from step 73 to step 76, in which the additional information is deleted from the main memory 214, and the transmission routine is exited without transmitting the additional information onto the communications network 400.

According to the embodiment described above, even if the user is not present at the location of the receiver 100 or if the user is not aware of the program in advance, only information desired by the user is transferred to a location remote from the location of the receiver 100 so that the user is allowed to receive the information at the remote location.

More specifically, for example, by allowing the user to receive a program broadcast in Tokyo by the receiver 100 and the PC 200 provided at home and to transmit the additional information onto the communications network 400, the user is allowed to receive the additional information using the PC 510, the PC 520, the cellular phone 530, the pager 540, etc. at a location on business or travel where the program is not broadcast. Furthermore, for example, the user using the receiver 100 and the PC 200 is allowed to transfer the additional information including the key information to a user of the PC 510, etc.

As described earlier, the additional information is, for example, of the type that includes a header portion and a data portion. In this case, by implementing so that the receiver 100 transmits to the PC 200 the header portion as well as the data portion of the additional information, the user is allowed to set information which may be included in the header portion of the additional information, for example, information indicating the format of the payload in the data portion, as key information, so that only the payload in the data portion is stored on the storage device 215 of the PC 200 and transmitted onto the communications network 400.

Although the embodiment has been described in the context of transmitting only additional information including key information onto the communications network 400, the method may be such that in addition to the additional information, audio information of the associated program is also transmitted from the receiver 100 to the PC 200, so that the additional information including the key information and the audio information of the associated program are transmitted from the PC 200 onto the communications network 400. Accordingly, the user is allowed to display the additional information and to listen to the audio information at a location remote from the receiver 100.

Furthermore, information obtained by the PC 200, for example, a timestamp, user information such as tags and headings input by the user, may be added to the additional information file as accompanying information and transmitted onto the communications network 400, so that the file can be readily searched and browsed on the information processing terminal at the destination.

Furthermore, depending on the type of digital radio broadcast, additional information of all the programs in broadcast including the additional information of the program being received can be received. In that case, the receiver 100 receives the additional information of all the programs in broadcast and transmits the additional information to the PC 200, and the PC 200 transmits additional information including key information onto the communications network 400. Accordingly, additional information of other programs as well as that of the program being received by the receiver 100 can be obtained at the information processing terminal at the destination.

Second Embodiment

According to a second embodiment of additional information transfer method, in the system described already, it is determined on the receiver 100 whether the key information is included in the received additional information, and if the key information is included, the additional information is transmitted from the receiver 100 to the PC 200, and further transmitted from the PC 200 onto the communications network 400, so that the additional information is transferred to an information processing terminal at a specified destination.

The key information is set in the PC 200, for example, by the user using the operation unit 240 in advance, and transmitted from the PC 200 to the receiver 100 when a connection is established between the receiver 100 and the PC 200 via the communications means 300. Alternatively, the key information may be set in advance by the user in the receiver 100 using the operation unit 140 thereof.

Also in the second embodiment, software for the transfer routine to be executed by the CPU 121 of the receiver 100 is implemented so that when the CPU 121 determines whether the key information is included in the additional information, it is determined that the key information is included in the additional information if the additional information only differs from the key information within several variations of description as described earlier. The transfer routine on the side of the receiver 100 in this embodiment is basically the same as in the embodiment described earlier.

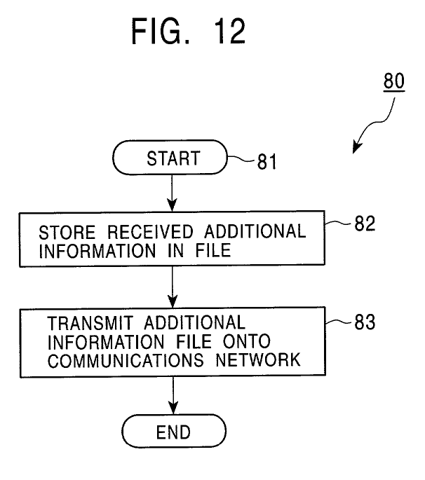

FIGS. 6 and 12 respectively show transmission routines to be executed by the CPU 121 of the receiver 100 and the CPU 211 of the PC 200 when additional information is selected on the receiver 100.

Referring to FIG. 6, the CPU 121 of the receiver 100 starts the transmission routine 30 on the side of the receiver 100 upon reception of a broadcast in step 31. First, in step 32, it is determined whether the additional information of the received program has been obtained. If the additional information has been obtained, the routine proceeds to step 33, in which the additional information is stored in the memory 130. The routine then proceeds to step 34, in which it is determined whether the key information which has been transferred from the PC 200 to the receiver 100 or which has been set in the receiver 100 is included in the additional information. If the key information is included, the routine proceeds from step 34 to step 35, in which the data communications unit 170 transfers the additional information to the PC 200.

If the key information is not included in the additional information stored in the memory 130, the transmission routine is exited without transmitting the additional information to the PC 200.

Referring next to FIG. 12, the CPU 211 of the PC 200 starts the transmission routine 80 on the side of the PC 200 when the data communications unit 270 receives the additional information from the receiver 100 in step 81. First, in step 82, the received additional information is directly stored in the storage device 215 as an additional information file. The routine then proceeds to step 83, in which the network communications unit 280 transmits the additional information file onto the communications network 400.

Also in the second embodiment, the additional information file is converted into a format based on a protocol for the communications network 400, assigned an ID of the PC 200 at the source, and an ID of an information processing terminal at a user-specified destination before being transmitted onto the communications network 400. Accordingly, the additional information including the key information can be received at the information processing terminal at the specified destination.

According to the second embodiment described above, similarly to the first embodiment, even if the user is not present at the location of the receiver 100 or if the user is not aware of the program in advance, only information desired by the user is transferred to a location remote from the location of the receiver 100 so that the user is allowed to receive the information at the remote location.

Also in the second embodiment, if the additional information includes a header portion and a data portion, the user is allowed to set information which may be included in the header portion of the additional information as key information. Furthermore, the method may be such that in addition to the additional information including the key information, audio information of the associated program is transmitted from the receiver 100 to the PC 200, and further transmitted from the PC 200 onto the communications network 400, so that the additional information and the audio information are transferred to an information processing terminal at a destination. Furthermore, information obtained by the PC 200 may be added to the additional information file as accompanying information and transmitted onto the communications network 400.

Furthermore, the method may be such that the additional information of all the programs in broadcast is received, and additional information including the key information is transferred from the receiver 100 and stored on the PC 200, and further transmitted from the PC 200 onto the communications network 400, so that the additional information is transferred to an information processing terminal at a destination.

Other Embodiments

Although the embodiments have been described in the context of receiving a digital radio broadcast in which additional information is multiplexed with audio information and transferring the additional information from an information processing terminal at a source to an information processing terminal at a destination via a communications network, without limitation to digital radio broadcasting, the present invention may be generally applied to cases where a broadcast in which additional information multiplexed with audio or video information is received and the additional information is transferred from an information processing terminal at a source to an information processing terminal at a destination via a communications network, for example, a digital television broadcast in which additional information is multiplexed with video (and audio) information.

Furthermore, the present invention may be applied to a case where a receiver is incorporated in an information processing terminal at a source and integrated therewith.

As described above, according to the present invention, even if the user is absent at the location of a receiver during reception or if the user is not aware of a program in advance, only additional information desired by the user is correctly transferred to and received at a location remote from the receiver.

What is claimed is:

1. A method of storing additional information, comprising the steps of:
receiving additional information obtained and transferred by a receiver capable of receiving a broadcast in which the additional information is multiplexed with main information including an audio signal or a video signal;
determining whether preset key information is included in the transferred additional information; and
storing the additional information in a storage medium if the key information is included.

2. A method of storing additional information according to claim 1, wherein if the additional information includes a data portion consisting of a payload and a header portion consisting of information associated with the payload, information which may be included in the header portion of the additional information is set as the key information, and if the key information is included in the header portion, the additional information including the header portion is stored in the storage medium.

3. A method of storing additional information according to claim 1, wherein if the additional information includes a data portion consisting of a payload and a header portion consisting of information associated with the payload, information which may be included in the header portion of the additional information is set as the key information, and if the key information is included in the header portion, the data portion associated with the header portion is stored in the storage medium.

4. A method of storing additional information according to claim 1, wherein said storing step stores, in addition to the additional information including the key information, the main information of the associated program in the storage medium.

5. A method of storing additional information according to claim 1, wherein said storing step stores accompanying information in association with the additional information.

6. A method of storing additional information according to claim 1, wherein said receiver also receives additional information of a program other than the program being received and transfers the additional information.

7. A method of storing additional information according to claim 1, further comprising the steps of transferring the additional information stored in the storage medium to said receiver, wherein said receiver displays the transferred additional information on a display unit of thereof.

8. A method of transferring additional information, comprising the steps of:
receiving a broadcast in which additional information is multiplexed with main information including an audio signal or a video signal, thereby obtaining the additional information;
determining whether preset key information is included in the additional information obtained; and
transferring the additional information to an external device if the key information is included.

9. A method of transferring additional information according to claim 8, wherein if the additional information includes a data portion consisting of a payload and a header portion consisting of information associated with the payload, information which may be included in the header portion of the additional information is set as the key information, and if the key information is included in the header portion, the additional information including the header portion is transferred to the external device.

10. A method of transferring additional information according to claim 8, wherein if the additional information includes a data portion consisting of a payload and a header portion consisting of information associated with the payload, information which may be included in the header portion of the additional information is set as the key information, and if the key information is included in the header portion, the data portion associated with the header portion is transferred to the external device.

11. A method of transferring additional information according to claim 8, wherein said transferring step transfers, in addition to the additional information including the key information, the main information of the associated program to the external device.

12. A method of transferring additional information according to claim 8, wherein said receiving and obtaining step also receives and obtains additional information of a program other than the program being received.

13. A method of transferring additional information according to claim 8, further comprising the step of transferring the additional information stored in the storage medium to said receiver, wherein said receiver displays the transferred additional information on a display unit thereof.

14. A method of transferring additional information according to claim 8, wherein said determining step stores the additional information in storage means if it is determined that the key information is included, and said transferring step transfers the additional information stored in the storage means to the external device at a predetermined timing.

15. A method of transferring additional information according to claim 8, wherein said determining step stores the additional information in storage means if it is determined that the key information is included, and said transferring step deletes the additional information from the storage means after the additional information has been transferred.

16. A method of storing additional information, comprising the steps of:
receiving a broadcast in which additional information is multiplexed with main information including an audio signal or a video signal, thereby obtaining the additional information;
determining whether preset key information is included in the additional information obtained;
transferring the additional information to an information processing terminal if the key information is included; and
storing the additional information transferred to the information processing terminal in a storage medium of the information processing terminal.

17. A method of storing additional information according to claim 16, wherein if the additional information includes a data portion consisting of a payload and a header portion consisting of information associated with the payload, information which may be included in the header portion of the additional information is set as the key information, and if the key information is included in the header portion, the additional information including the header portion is transferred to the information processing terminal and stored in the storage medium.

18. A method of storing additional information according to claim 16, wherein if the additional information includes a data portion consisting of a payload and a header portion consisting of information associated with the payload, information which may be included in the header portion of the additional information is set as the key information, and if the key information is included in the header portion, the data portion associated with the header portion is transferred to the information processing terminal and stored in the storage medium.

19. A method of storing additional information according to claim 16, wherein said transferring step transfers, in addition to the additional information including the key information, the main information of the associated program to said information processing terminal, and said storing step stores the transferred additional information and main information in the storage medium of said information processing terminal.

20. A method of storing additional information according to claim 16, wherein said storing step stores information obtained in the information processing terminal in association with the additional information.

21. A method of storing additional information according to claim 16, wherein said receiving and obtaining step also receives and obtains additional information of a program other than the program being received.

22. A method of storing additional information according to claim 16, further comprising the step of transferring the additional information stored in the storage medium to said receiver, wherein said receiver displays the transferred additional information on a display unit thereof.

23. A method of transferring additional information according to claim 16, wherein said determining step determines the additional information in storage means if it is determine that the key information is included, and said transferring step transfers the additional information stored in the storage means to the information processing terminal at a predetermined timing.

24. A method of storing additional information according to claim 16, wherein said transferring step transfers the additional information in response to a transfer request issued by the information processing terminal.

25. A method of storing additional information according to claim 16, wherein said determining step stores the additional information in storage means if it is determined that the key information is included, and said transferring step deletes the additional information from the storage means after the additional information has been transferred.

26. A receiver comprising:
a receiving unit capable of receiving a broadcast in which additional information is multiplexed with main information including an audio signal or a video signal;
a control unit which determines whether key information preset in said receiver is included in the additional information received by said receiving unit; and
a communications unit which transfers the additional information received by said receiving unit to an external device if said control unit determines that the key information is included in the additional information.

27. A receiver according to claim 26, wherein if the additional information includes a data portion consisting of a payload and a header portion consisting of information associated with the payload, information which may be included in the header portion of the additional information is set as the key information, and if the key information is included in the header portion, the additional information including the header portion is transferred to the external device.

28. A receiver according to claim 26, wherein if the additional information includes a data portion consisting of a payload and a header portion consisting of information associated with the payload, information which may be included in the header portion of the additional information is set as the key information, and if the key information is included in the header portion, the data portion associated with the header portion is transferred to the external device.

29. A receiver according to claim 26, wherein in addition to the additional information including the key information, the main information of the associated program is transferred to the external device.

30. A receiver according to claim 26, wherein said receiver unit also receives additional information of a program other than the program being received.

31. A receiver according to claim 26, further comprising a display unit for displaying additional information, wherein at least part of the additional information transferred to the external device is transferred from the external device via said communications unit, so that the transferred additional information is displayed on said display unit.

32. A receiver according to claim 26, further comprising storage means for storing additional information, wherein the additional information is stored in said storage means if it is determined that the key information is included, and the additional information stored in said storage means is transferred to the external device at a predetermined timing.

33. A receiver according to claim 26, further comprising storage means for storing additional information, wherein the additional information is stored in said storage means if it is determined that the key information is included, and the additional information is deleted from said storage means after the additional information has been transferred.

34. An information processing terminal comprising:
a data communications unit for receiving additional information obtained and transferred by a receiver capable of receiving a broadcast in which the additional information is multiplexed with main information including an audio signal or a video signal;
a control unit which determines whether preset key information is included in the transferred additional information; and
storage means for storing the additional information if said control unit determines that the key information is included in the additional information.

35. An information processing terminal according to claim 34, wherein if the additional information includes a data portion consisting of a payload and a header portion consisting of information associated with the payload, information which may be included in the header portion of the additional information is set as the key information, and if the key information is included in the header portion, the additional information including the header portion is stored in said storage means.

36. An information processing terminal according to claim 34, wherein if the additional information includes a data portion consisting of a payload and a header portion consisting of information associated with the payload, information which may be included in the header portion of the additional information is set as the key information, and if the key information is included in the header portion, the data portion associated with the header portion is stored in said storage means.

37. An information processing terminal according to claim 34, wherein if said control unit determines that the key information is included in the additional information, in addition to the additional information including the key information, the main information of the associated program is stored in said storage means.

38. An information processing terminal according to claim 34, wherein if said control unit determines that the key information is included in the additional information, accompanying information obtained by said information processing terminal is stored in association with the additional information.

39. An information processing terminal according to claim 34, at least part of the additional information stored in said storage means is transferred to said receiver via said communications unit.

40. A method of transferring additional information, comprising the steps of:
transmitting to a first information processing terminal additional information obtained by a receiver capable of receiving a broadcast in which the additional information is multiplexed with main information including an audio signal or a video signal;
determining on said first information processing terminal whether key information preset in said first information processing terminal is included in the transmitted additional information; and
transferring the additional information from said first information processing terminal to a second information processing terminal at a destination if the key information is included.

41. A method of transferring additional information according to claim 40, wherein if the additional information includes a data portion consisting of a payload and a header portion consisting of information associated with the payload, information which may be included in the header portion of the additional information is set as the key information, and if the key information is included in the header portion, the additional information including the header portion is transferred to said second information processing terminal.

42. A method of transferring additional information according to claim 40, wherein if the additional information includes a data portion consisting of a payload and a header portion consisting of information associated with the payload, information which may be included in the header portion of the additional information is set as the key information, and if the key information is included in the header portion, the data portion associated with the header portion is transferred to said second information processing terminal.

43. A method of transferring additional information according to claim 40, wherein said transmitting step transmits, in addition to the additional information, the main information of the associated program to said first information processing terminal, and said transferring step transfers, in addition to the additional information including the key information, the main information of the associated program to said second information processing terminal.

44. A method of transferring additional information according to claim 40, wherein said transferring step transfers accompanying information obtained by said first information terminal in association with the additional information.

45. A method of transferring additional information according to claim 40, wherein said receiver also receives additional information of a program other than the program being received and transmits the additional information.

46. A method of transferring additional information, comprising the steps of:
receiving additional information by a receiver capable of receiving a broadcast in which the additional information is multiplexed with main information including an audio signal or a video signal;
determining on said receiver whether key information preset in said receiver is included in the received additional information;
transmitting the additional information to a first information processing apparatus at a source if the key information is included; and
transferring the additional information from said first information processing terminal to a second information processing terminal at a destination via a communications network.

47. A method of transferring additional information according to claim 46, wherein if the additional information includes a data portion consisting of a payload and a header portion consisting of information associated with the payload, information which may be included in the header portion of the additional information is set as the key information, and if the key information is included in the header portion, the additional information including the header portion is transmitted to said first information processing terminal.

48. A method of transferring additional information according to claim 46, wherein if the additional information includes a data portion consisting of a payload and a header portion consisting of information associated with the payload, information which may be included in the header portion of the additional information is set as the key information, and if the key information is included in the header portion, the data portion associated with the header portion is transmitted to said first information processing terminal.

49. A method of transferring additional information according to claim 46, wherein said transmitting step transmits, in addition to the additional information including the key information, the main information of the associated program to said first information processing terminal.

50. A method of transferring additional information according to claim 46, wherein said transferring step transfers accompanying information obtained by said first information processing terminal in association with the additional information.

51. A method of transferring additional information according to claim 46, wherein said receiver also receives additional information of a program other than the program being received.

52. An information processing terminal comprising:
a data communications unit for receiving additional information obtained and transferred by a receiver capable of receiving a broadcast in which the additional information is multiplexed with main information including an audio signal or a video signal;
a control unit which determines whether preset key information is included in the transferred additional information; and
a network communications unit for transmitting the additional information onto a communications network if said control unit determines that the key information is included in the additional information.

53. An information processing terminal according to claim 52, wherein if the additional information includes a data portion consisting of a payload and a header portion consisting of information associated with the payload, information which may be included in the header portion of the additional information is set as the key information, and if the key information is included in the header portion, said network communications unit transmits the additional information including the header portion.

54. An information processing terminal according to claim 52, wherein if the additional information includes a data portion consisting of a payload and a header portion consisting of information associated with the payload, information which may be included in the header portion of the additional information is set as the key information, and if the key information is included in the header portion, said network communications unit transmits the data portion associated with the header portion.

55. An information processing terminal according to claim 52, wherein if said control unit determines that the key information is included in the additional information, said network communications unit transmits, in addition to the additional information including the key information, the main information of the associated program.

56. An information processing terminal according to claim 52, wherein if said control unit determines that the key information is included in the additional information, said network communications unit transmits accompanying information obtained by said information processing terminal in association with the additional information.
